(19) United States
(12) Patent Application Publication
(10) Pub. No.: US 2009/0100145 A1
(43) Pub. Date: Apr. 16, 2009

(54) METHOD FOR INTERNET-BASED APPLICATIONS TO ENABLE INTERNET SERVICE PROVIDERS TO SPECIFY LOCATION CONTEXT

(75) Inventors: Christopher T. Szeto, San Jose, CA (US); Benjamin Grey Halsted, San Jose, CA (US)

Correspondence Address: BEYER LAW GROUP LLP/YAHOO, PO BOX 1687, CUPERTINO, CA, 95015-1687, US

(73) Assignee: YAHOO! INC., Sunnyvale, CA (US)

(21) Appl. No.: 11/873,012

(22) Filed: Oct. 16, 2007

(51) Int. Cl. G06F 15/16; G06F 15/173; G06F 15/177

(52) U.S. Cl. 709/217; 709/204; 709/220

(57) ABSTRACT

A client computing device accesses a communications network via a network service provider, including exercising to at least one other user using a network-based service. A request for location context is provided, destined to the network-based service via the network service provider. The network service provider intercepts the location context request and provides the location context to the client computing device, which is then provided to the at least one other user using the network-based service (such as a status message of an instant messaging service).

### BACKGROUND

Providing internet access via a wireless hotspot has become increasingly popular. In general, a hotspot serves as a local access point for some internet service provider (ISP) to provide a number of users with access to the internet. A hotspot, by its nature, is associated with a particular location (although the particular location may be changing, such as if the hotspot is associated with an airplane or other transportation conveyance). Frequent network-based communication services that are often accessed via a hotspot include email and instant messaging.

It is known for instant messaging user interfaces to show a particular user the location of other users accessible to that particular user. For example, some IM services shows other users nearby. In particular, some IM services allows users to manually declare their location to the service—usually a physical address. Some IM services, knowing the IP address from which a user is accessing the service, use the user's IP address to attempt to approximate the user's location. Yet other IM services use a list of nearby wireless hotspots and using a known range of a signal, approximate the distance from each other to deduce a physical location. Some Mobile IM services use a GPS signal provided from a user's mobile device to determine an accurate location for the user.

### SUMMARY

In accordance with an aspect, a client computing device is operated to access a communications network via a network service provider. The client computing device is operated to exercise ties from the user of the client computing device to at least one other user, over the communications network accessed by the client computing device via the network service provider using a network-based service. The client computing device is operated to cause a request for location context to be provided, destined to the network-based service via the network service provider. The client computing device is operated to receive a location context, from the network service provider, in response to the location context request and to cause an indication of the location context to be provided to the at least one other user using the network-based service.

In accordance with another aspect, a network service provider is operated to provide a client computing device access to a communications network, including to exercise ties from the user of the client computing device to at least one other user, using a network-based service provided over the communications network accessed by the client computing device via the network service provider. A request is received from the client computing device to the network-based service for location context. The network service provider intercepts the location context request and provides, to the client computing device, a location context associated with the network service provider.

In accordance with another aspect, the network-based service causes the network service provider to be pre-configured to intercept requests from the client computing device to the network-based service for location context based on the requests to be intercepted having a particular format. Further, the network-based service causes the network service provider to be pre-configured to provide the location context to the client computing device according to a particular specification.

Additional aspects will become apparent from the description and appended claims.

### BRIEF DESCRIPTION OF THE DRAWINGS

FIG. 1 illustrates an example architecture in which a user is tied to other users via network-based services accessed by the user via a hotspot, and the other users are automatically provided a representation of the hotspot location.

FIG. 2 is a screenshot of an example buddy list of one of the other users (i.e., the user on the airplane of FIG. 1 is tied to the user to whom the FIG. 2 screenshot is presented by an instant messaging service.

FIG. 3 is an example screen shot illustrating presentation of a representation of the hotspot location for the hotspot “Sara Himmel” is employing to access the instant messaging service.

FIG. 4 is a flowchart illustrating an example method by which, for a user who is tied to other users via network-based services accessed by the user via a hotspot, the other users are enabled to be automatically provided a representation of the hotspot location.

FIG. 5 is similar to FIG. 1, but FIG. 5 illustrates two airplanes.

FIG. 6 is similar to FIG. 1, but illustrates a configuration in which an internet service provider 113 serves stores of a company.

FIG. 7 is a simplified diagram of a network environment in which specific embodiments of the present invention may be implemented.

### DETAILED DESCRIPTION

The inventors have realized that, for a user who is communicating with friends using an instant messaging service accessed by the user via an internet service provider, it may be desirable to both the user and to the internet service provider to enable the user to share the user's location with his or her friends over an instant messaging service. The friends of the user can then learn, for example, about both the physical location of the user and some context of the user's physical location.

As one example, an access point of an internet service provider may be provided on an airplane for use by passengers on the airplane to, perhaps among other things, utilize network-based services to communicate with friends and contacts. An example of such a network-based service is instant messaging, also known as IM. The internet service provider may operate such that, as the IM service is exercised, a representation of the location of the internet service provider's access point (and, thus, the user's physical location) is revealed to the other users. The representation may not, on its face, provide the actual location of the access point. Rather, it may be necessary to access a service to determine the location from the location indication. For example, the access point may be on an airplane, and the indication may be a flight number or tail number of the airplane, and a flight status service may be accessed to determine the actual location of the airplane having that flight number or tail number.

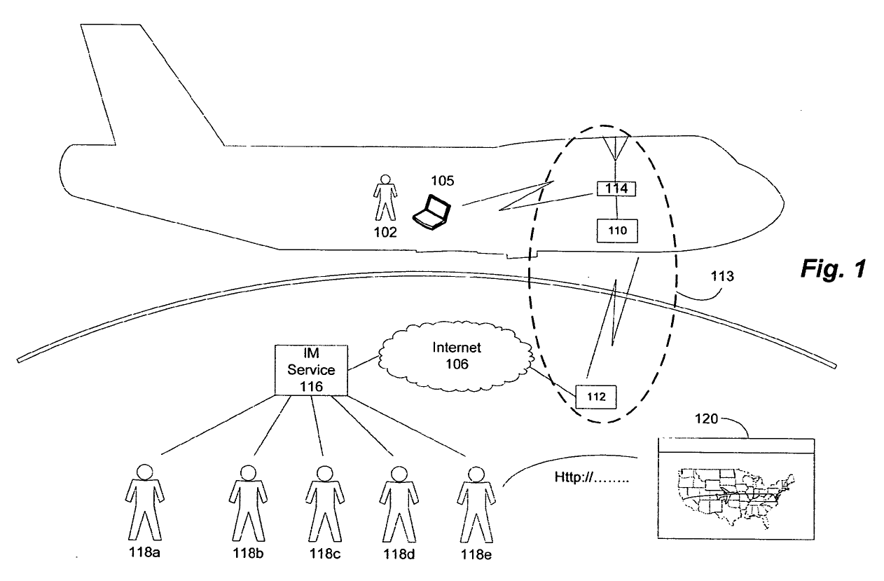

FIG. 1 illustrates a system using the airplane example, although many of the concepts illustrated in FIG. 1 are more generally applicable, and some more general applications will be described later. Referring to FIG. 1, a user 102, who is a passenger on an airplane 104, access the internet 106, via an internet service provider 113 using a computer or internet-capable device (such as a WiFi-capable telephone, for example) 105 communicatively connected to access point 114 of the internet service provider 113.

It is noted that many people access internet service providers via an access point, such as a hotspot. Access points are usually in public places (libraries, hotels, schools, coffee shops, internet cafés. Some access points require users to pay to access an internet service provider via the access point while others are free to use. Further, some access points are for wired connections while others are for wireless connections.

Turning back to FIG. 1, the computer 105 may be connected to the internet service provider 113 via a hub 114 (e.g., in a wireless or wired manner). In this example, the hub 114 is connected to a server 110 on the airplane, which is connected to a server 112, physically located on the ground and in communication with the server 110 by, for example, a satellite or radio link, or some other suitable communications link. In this case, the “location” of the hub 114 is to be considered the location from which users access the internet service provider 113.

More specifically, the access to the internet 106, via the internet service provider 113, is to access an instant messenger service 116 for possibly sending instant messages among the user on the airplane and other users (denoted by reference numeral 118). A buddy list is a list of all other users designated by the user (or designated for the user) as users with whom the user exercises ties via the instant messenger service 116. In fact, displaying the buddy list itself is involves exercising the ties with the other users on the buddy list via the instant messenger service 116.

An instant messaging service typically provides online presence and status to the friends/contacts of the user. Presence usually indicates if the user is online, offline, busy, or idle and helps contacts determine whether or not the user is available to chat. Status messages are broadcasted to contacts to explain what the user is doing or thinking. Common status messages include “Out to lunch”, “Be right back”, and most instant messaging services allow the user to enter their own status messages. Status messages may also contain URL's or meta-data that allows an instant messenger client to render the status as a link that the contact can click on. Examples of these clickable statuses include “View my webcam” where the link starts a webcam viewer; “Listening to Madonna: Vogue” where the link starts a music player to listen to the same song. The user's presence and status of a user is broadcast to friends as a status message over the IM service. A status message may also contain additional meta data not shown to the user but that the client can process to provide additional functionality.

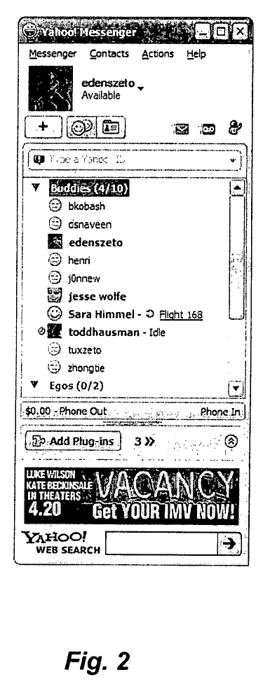

FIG. 2 is a screenshot of an example buddy list of one of the other users 118 (in this case, as shown in the heading portion 202, of the user having the IM identification of “edenszeto.” It can be seen that the entry 204 for “Sara Himmel” includes the text “Flight 168” (reference numeral 206) which is the identifying text for an underlying link.

In some examples, the underlying link for which the text 206 is the identifying text includes a link that has been provided to the application by an internet service provider (such as the internet service provider 113 in FIG. 1) and directly identifies the physical location at which the internet service provider is being accessed (such as the physical location of the access point 114). In other examples, the link includes a location indication that does not directly identify the physical location, such that when that location indication is provided to an intermediate service, the intermediate service may operate on the location indication in view of additional information to determine the physical location from which the internet service provider is accessed. Referring back to FIG. 1, the location status display 120 may have resulted from the user 118e activating a link that has been inserted by an internet service provider such as the internet service provider 113 in FIG. 1.

As an example of directly identifying the location with which access to an internet service provider is associated, the identification may include a longitude and latitude of an airplane from which access to the internet service provider is made. As an example of a location indication that may be operated on in view of additional information to determine the physical location of the access, the identification may include a flight number or an airplane tail number, for example. This information may be provided to a service that maintains information about flight status (which is additional information not provided from the internet service provider) and, based thereon and on the flight number (or tail number, or other characterization), determine the physical location from which the access to the internet service provider is made. One such service is provided at www.flightaware.com. In general, access to the service would be via an API provided by the service, although there may be other methods to access the service.

As mentioned above, other metadata may be provided by the hotspot along with the location indication. The name of the provider is an interesting piece of meta-data to pass along as it can be used to provide marketing value to the provider of the hotspot.

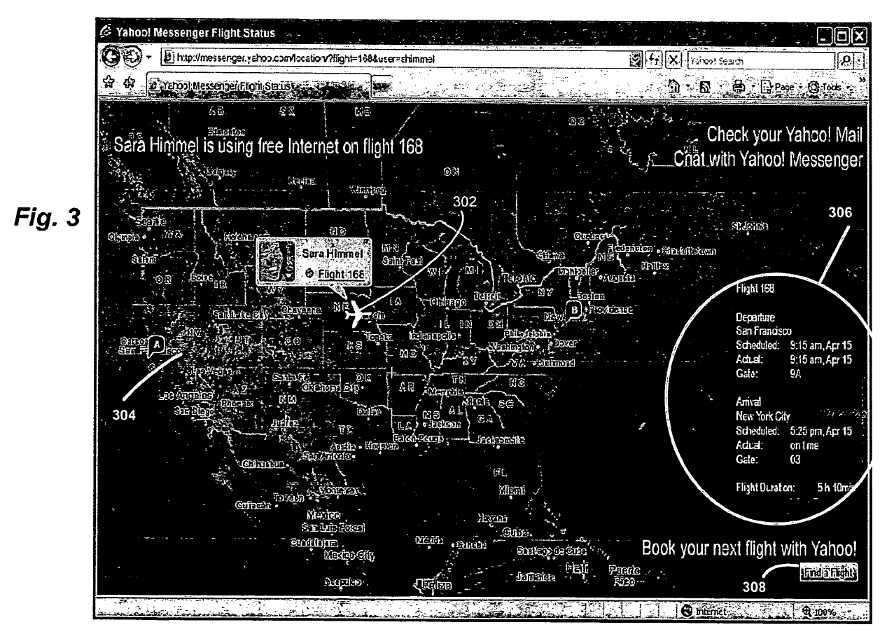

However determined, operating on the location indication may cause the location information to be presented to the other user. For example, the listing for Sara Himmel, rather than being “Sara Himmel—Flight 168,” may instead be “Sara Himmel—Flight 168, over Nebraska.” Furthermore, the presence link may include a link to a presentation of location information. FIG. 3 is an example screen shot illustrating presentation of location information for “Sara Himmel.” In the FIG. 3 example, presented, for example, as a result of a user activating a link of the buddy list entry for “Sara Himmel,” the location information is displayed as part of the buddy list, the airplane icon 302 is shown overlaying a United States map 304 over Nebraska, indicating that the location of the hotspot associated with the user Sarah Himmel is over Nebraska. In addition, an indication 306 provides additional information regarding the Sarah Himmel's flight.

In the FIG. 3 example as well, the location display is co-branded by the airline providing access to the internet service provider, including providing a link 308 for the other user, to which the location information is being presented, to activate for accessing a web site of the co-brander.

As noted above, in some examples, in conjunction with providing the location of the user to the other users, the other users may also be provided functionality with respect to the entity associated with the internet access provider. In the airplane example, the functionality may be functionality for the other users to purchase airplane tickets. In the coffee outlet example, the functionality may be functionality for the other users to purchase stored value cards or merchandise, or may be functionality for the other users to purchase items (such as a cup of coffee) for the user located at the coffee outlet.

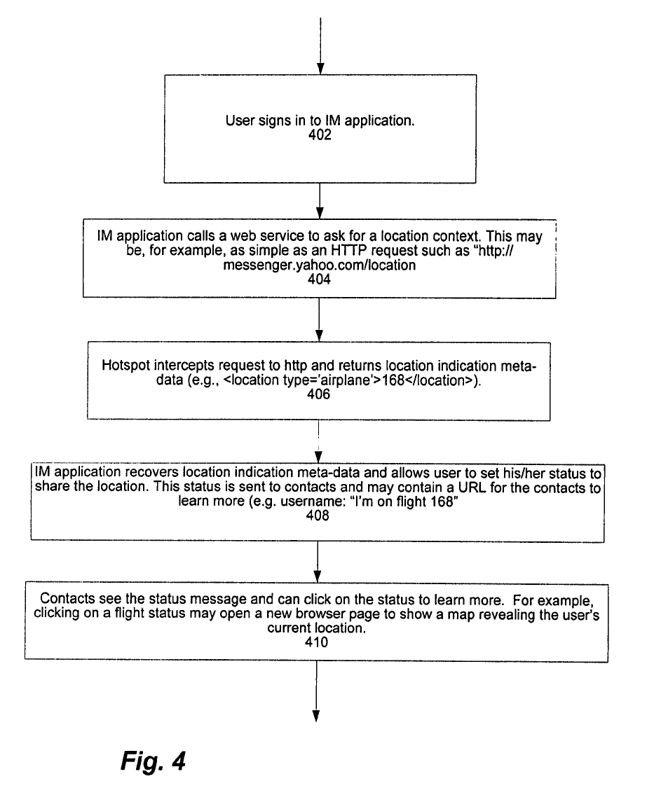

Turning now to FIG. 4, a flowchart is provided to illustrate an example method by which, for a user who is connected to other users via an IM service accessed via an internet service provider, the other users are enabled to be automatically provided an indication of the location from which the internet service provider is accessed. At 402, the user signs in to an IM application (using, for example, a web-based application or a client-based application). As part of the operation of the IM application, the IM application (at 404) calls a web service to request a location context. This may be, for example, as simple as an HTTP request such as http://messenger.yahoo.com/location. At 406, the internet service provider intercepts the web request and returns location indication metadata (e.g., <location type-‘airplane’?168</location>). The location indication metadata is in a format that can be understood by the IM application. Typically this format is some form of simple XML.

For example, the IM service may have published a URL indication (e.g., http://messenger.yahoo.com/location) as a location request to be intercepted. The IM service may have also published a specification of how the location indication is to be provided to the IM application. Thus, for example, the internet service provider may be pre-configured, based on the publication by the IM service, to intercept the URL indication and to provide the location indication as specified.

The location indication may be provided from anywhere within the internet service provider's network, including from the access point. For example, if the access point does not intercept the location context request, a next server of the internet service provider network may intercept and act on the request. (In the event the IM application makes a location request in an environment that does not or cannot provide a response to the request, then the application operates as if there is no location context.)

At 408, the IM application recovers the location indication metadata and can use the location context to offer relevant functionality for the IM service. One use of the location context is to allow the user to set his/her IM status to share the location. The status is sent to his/her IM contacts and may contain a URL for the contacts to learn more (e.g., username: I'm on flight 168.” At 410, the contact sees the status message and can activates the status message (e.g., click on the status message) to learn more. For example, the contact activating the status message may cause a new browser window to open to show a map revealing the user's current location, such as illustrated in the FIG. 3 screenshot.

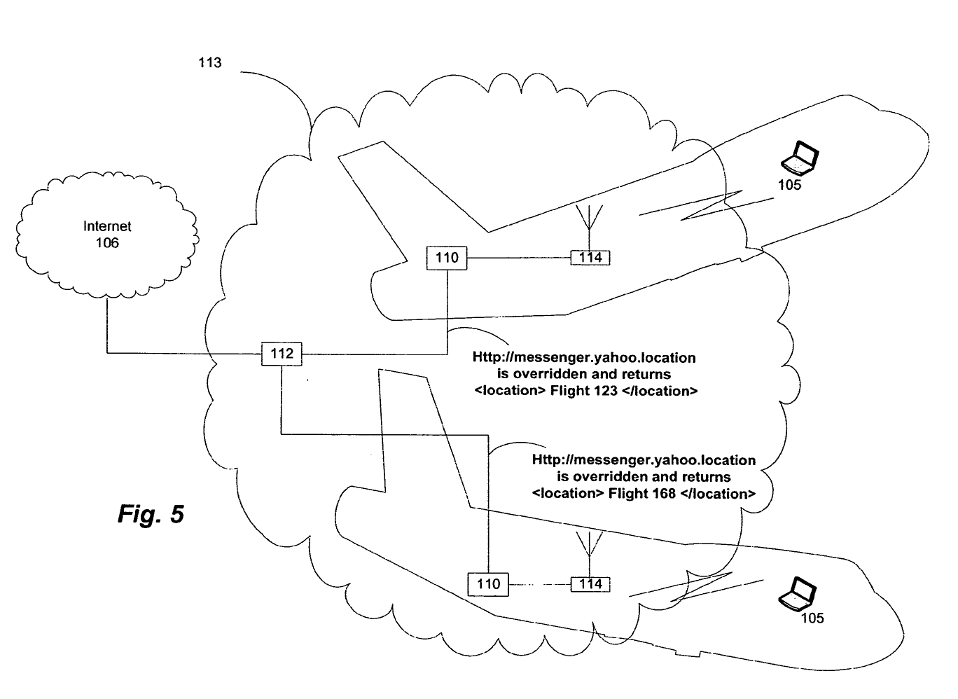

FIG. 5 is similar to FIG. 1, but FIG. 5 illustrates two airplanes 502 and 504, and a server 110 of the internet service provider 113, on each airplane 502 and 504, overrides the location context request provided from the computing devices 105 accessing the internet service provider 113 via an access point 114. In overriding the location context request, the server 110 of each airplane provides a location context for that respective airplane (i.e., in FIG. 5, “Flight 123” or “Flight 168”, as appropriate).

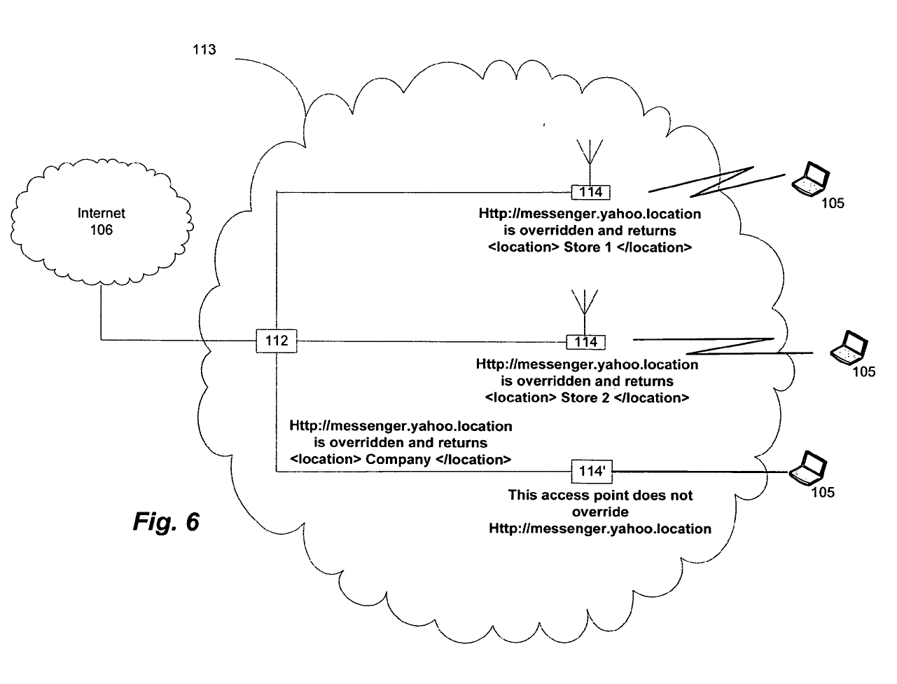

FIG. 6 illustrates a configuration in which an internet service provider 113 serves stores of a company. Two access points operate in a manner similar to that described with reference to FIG. 5. That is, the two access points 114 operate to override the location context request provided from a computing device 105 to provide a location context for the store with which the access point 114 is associated (i.e., in FIG. 6, “Store 1” or “Store 2”, as appropriate.) The access point 114′, by contrast, does not operate to override the location context request and, thus, the location context request is provided to a next server (in this case, server 112) in a network of servers of the internet service provider 113. In this case, the server 112 overrides the location context request and provides a location context for the company with which the internet service provider 113 is associated. In some examples, functionality within the server 112 may determine that the location context request has been provided via the access point 114′ and provide the location context for the store with which the access point 114′ is associated, even though the access point 114′ did not itself override the location context request.

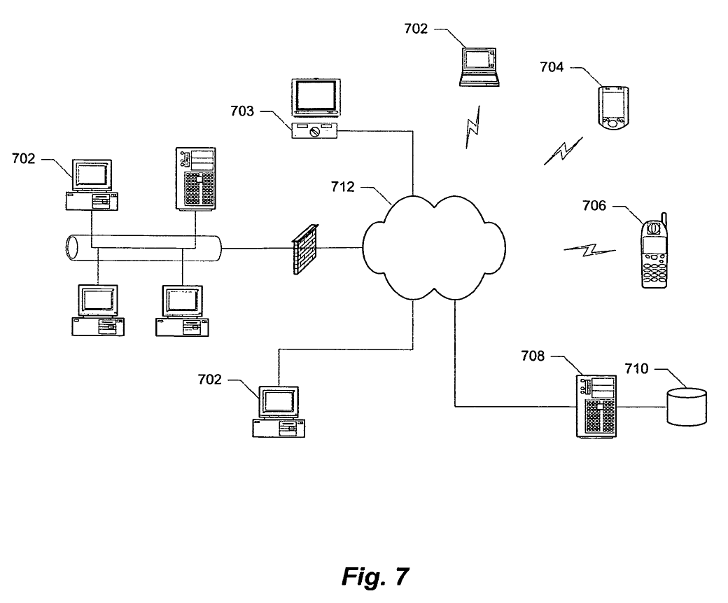

Embodiments of the present invention may be employed in any of a wide variety of computing contexts to provide hotspot location information For example, as illustrated in FIG. 7, implementations are contemplated in which users may interact with a diverse network environment via any type of computer (e.g., desktop, laptop, tablet, etc.) 702, media computing platforms 703 (e.g., cable and satellite set top boxes and digital video recorders), handheld computing devices (e.g., PDAs) 704, cell phones 706, or any other type of computing or communication platform.

According to various embodiments, applications may be executed locally, remotely or a combination of both. The remote aspect is illustrated in FIG. 7 by server 708 and data store 710 which, as will be understood, may correspond to multiple distributed devices and data stores.

The various aspects of the invention may also be practiced in a wide variety of network environments (represented by network 712) including, for example, TCP/IP-based networks, telecommunications networks, wireless networks, etc. In addition, the computer program instructions with which embodiments of the invention are implemented may be stored in any type of computer-readable media, and may be executed according to a variety of computing models including, for example, on a stand-alone computing device, or according to a distributed computing model in which various of the functionalities described herein may be effected or employed at different locations.

What is claimed is:

1. A method of operating a client computing device, comprising:
operating the client computing device to access a communications network via a network service provider;
operating the client computing device to exercise ties from the user of the client computing device to at least one other user, over the communications network accessed by the client computing device via the network service provider using a network-based service;
operating the client computing device to cause a request for location context to be provided, destined to the network-based service via the network service provider; and
operating the client computing device to receive a location context, from the network service provider, in response to the location context request and to cause an indication of the location context to be provided to the at least one other user using the network-based service.

2. The method of claim 1, wherein:
operating the client computing device to cause an indication of the location context to be provided to the at least one other user includes causing a status message to be provided to the at least one other user including an indication of the location context using the network-based service.

3. The method of claim 1, wherein:
operating the client computing device to exercise ties from the user of the client computing device to at least one other user using a network-based service includes operating the client computing device to communicate with the at least one other user using an instant messaging service; and
operating the client computing device to cause an indication of the location context to be provided to the at least one other user includes causing an indication of the location context to be provided to the at least one other user as at least a portion of a status message of the instant messaging service.

4. The method of claim 1, wherein:
operating the client computing device to cause a request for location context to be provided to the network service provider includes making the location context to a particular URL which the network-service provider has been pre-configured to intercept and based on which the network-service provider has been pre-configured to provide the location context to the client computing device according to a particular specification.

5. The method of claim 1, further comprising:
operating the client computing device to cause a request for location context to be provided to the network service provider includes making the location context to a particular URL which the network-service provider has been caused the network service provider to be pre-configured by the network-based service to intercept and based on which the network-service provider has caused the network service provider to be pre-configured by the network-based service to provide the location context to the client computing device according to a particular specification.

6. A method of operating a network service provider, comprising:
providing a client computing device access to a communications network, including a client computing device being operated to exercise ties from the user of the client computing device to at least one other user, using a network-based service provided over the communications network accessed by the client computing device via the network service provider;
receiving a request from the client computing device to the network-based service for location context;
intercepting the location context request and providing, to the client computing device, a location context associated with the network service provider.

7. The method of claim 6, wherein:
the network service provider is organized hierarchically; and
at least some portions of the hierarchical organization are not configured to intercept the location context request.

8. The method of claim 7, wherein:
for each portion of the hierarchical organization configured to intercept the location context request, the network service provider is configured to provide a location context associated with that portion of the hierarchical organization in response to a location context request intercepted by that portion of the hierarchical organization.

9. The method of claim 6, wherein:
intercepting the location context request and providing, to the client computing device, a location context associated with the network service provider includes
intercepting a particular URL, provided from the client computing device, as the location context request; and
providing an XML-formatted location indication back to the client computing device.

10. The method of claim 7, further comprising:
pre-configuring the network service provider to intercept requests from the client computing device to the network-based service for location context based on the requests to be intercepted having a particular format; and
pre-configuring the network based service to provide the location context to the client computing device according to a particular specification.

11. The method of claim 6, further comprising:
by the network-based service, causing the network service provider be pre-configured to intercept requests from the client computing device to the network-based service for location context based on the requests to be intercepted having a particular format; and
by the network-based service, causing the network service provider to be pre-configured to provide the location context to the client computing device according to a particular specification.

12. A method of operating a system including a client computing device, a network service provider and a network service, comprising:
operating the client computing device to access a communications network via a network service provider;
operating the client computing device to exercise ties from the user of the client computing device to at least one other user, over the communications network accessed by the client computing device via the network service provider using a network-based service;
operating the client computing device to cause a request for location context to be provided, destined to the network-based service via the network service provider;
operating the network service provider to intercept the location context request destined to the network-based service and to provide, to the client computing device, a location context associated with the network service provider; and
operating the client computing device to cause an indication of the location context to be provided to the at least one other user using the network-based service.

13. The method of claim 12, further comprising:
by the network-based service, causing the network service provider be pre-configured to intercept requests from the client computing device to the network-based service for location context based on the requests to be intercepted having a particular format; and
by the network-based service, causing the network based service to be pre-configured to provide the location context to the client computing device according to a particular specification.

14. The method of claim 12, wherein:
operating the network service provider to intercept the location context request and to provide, to the client computing device, a location context associated with the network service provider includes
operating the network service provider to intercept a particular URL, provided from the client computing device, as the location context request; and
operating the network service provider to provide an XML-formatted location indication back to the client computing device.

15. A computer program product for operating a client computing device, the computer program product comprising at least one computer-readable medium having computer program instructions stored therein which are operable to cause at least one computing device to:
access a communications network via a network service provider;
exercise ties from the user of the client computing device to at least one other user, over the communications network accessed by the client computing device via the network service provider using a network-based service;
cause a request for location context to be provided, destined to the network-based service via the network service provider; and
receive a location context, from the network service provider, in response to the location context request and to cause an indication of the location context to be provided to the at least one other user using the network-based service.

16. The computer program product of claim 15, wherein:
the computer program instructions operable to cause the at least one computing device to cause a request for location context to be provided to the network service provider includes computer program instructions operable to cause the at least one computing device to make the location context to a particular URL which the network-service provider has been pre-configured to intercept and based on which the network-service provider has been pre-configured to provide the location context to the client computing device according to a particular specification.

17. The computer program product of claim 15, wherein:
the computer program instructions operable to cause the at least one computing device to cause a request for location context to be provided to the network service provider includes computer program instructions operable to make the location context to a particular URL which the network-service provider has been caused the network service provider to be pre-configured by the network-based service to intercept and based on which the network-service provider has caused the network service provider to be pre-configured by the network-based service to provide the location context to the client computing device according to a particular specification.

18. A computer program product for operating a network service provider, the computer program product comprising at least one computer-readable medium having computer program instructions stored therein which are operable to cause at least one computing device to:
provide a client computing device access to a communications network, including a client computing device being operated to exercise ties from the user of the client computing device to at least one other user, using a network-based service provided over the communications network accessed by the client computing device via the network service provider;
receive a request from the client computing device to the network-based service for location context;
intercept the location context request and provide, to the client computing device, a location context associated with the network service provider.

19. The computer program product of claim 18, wherein:
the computer program instructions are further operable to cause the at least one computing device to be pre-configured to intercept requests from the client computing device to the network-based service for location context based on the requests to be intercepted having a particular format to provide the location context to the client computing device according to a particular specification.

20. The computer program product of claim 18, wherein:
the computer program instructions are further operable to cause the at least one computing device to be pre-configured, based on a publication from the network-based service, to intercept requests from the client computing device to the network-based service for location context based on the requests to be intercepted having a particular format to provide the location context to the client computing device according to a particular specification.
